(19) United States
(12) Patent Application Publication
(10) Pub. No.: US 2011/0216115 A1
(43) Pub. Date: Sep. 8, 2011

(54) PRINTING METHOD AND PRINTING APPARATUS

(75) Inventors: Akito Sato, Matsumoto-shi (JP); Bunji Ishimoto, Matsumoto-shi (JP)

(73) Assignee: Seiko Epson Corporation, Tokyo (JP)

(21) Appl. No.: 13/040,452

(22) Filed: Mar. 4, 2011

(30) Foreign Application Priority Data
Mar. 5, 2010 (JP) 2010-048844

(51) Int. Cl. B41J 29/38

(52) U.S. Cl. 347/12

(57) ABSTRACT

In the printing method, on a medium transported in a transport direction, while nozzle rows including a plurality of nozzles move in a scanning direction intersecting the transport direction, ink is ejected from the nozzles, and dots are formed to print an image. Coordinates of dots formed by nozzles of a nozzle row center portion and coordinates of dots formed by nozzles of nozzle row end portions are measured with respect to a ruled line printed in advance along the transport direction by ejecting ink from the plurality of nozzles, and an amount of deviation in the scanning direction among the coordinates is calculated. Pixel data corresponding to the dots formed by the nozzles of the nozzle row end portions among pixel data indicating unit elements forming an image are shifted in the scanning direction according to the amount of deviation, to perform printing.

### BACKGROUND

1. Technical Field

The present invention relates to a printing method and a printing apparatus.

2. Related Art

Ink jet printers ejecting ink from nozzles by vibrating piezoelectric elements to perform printing have come into wide use. To print a straight line such as a ruled line using an ink jet printer, it is general to eject ink from the nozzles while moving a head having nozzle rows including a plurality of nozzles forward and backward in a direction (scanning direction) perpendicular to a transport direction of a medium. Meanwhile, since nozzles positioned at the center portion of the nozzle rows and nozzles positioned at end portions thereof have different ink ejecting characteristics, the time of landing the ejected ink onto the medium deviates and thus there is a case where the ruled line may not be straightly printed.

To solve such a problem, a method of controlling the piezoelectric elements to be driven is proposed, in which a plurality of patterns with different ink ejection times are printed in advance, and a driving signal is generated on the basis of a pattern with a minimal amount of deviation of the ink landing position (for example, JP-A-2006-167995).

According to the method described in JPA-2006-167995, the driving signal is generated on the basis of the preset ejecting pattern, and thus it is possible to correct the landing position of ink on the medium.

However, in the printer having such control means, the scale of the driving circuit increases in order to control a plurality of piezoelectric elements (e.g., 360 piezoelectric elements per one nozzle row) provided for each nozzle row. For this reason, there is a case where the nozzle rows are divided and the piezoelectric elements are controlled by a block unit. However, the piezoelectric elements cannot be controlled as a nozzle (piezoelectric element) unit, and thus there is a problem that deviations of the landing position cannot be accurately corrected in the scanning direction of the ink dots formed by the nozzles of the nozzle row end portions.

### SUMMARY

An advantage of some aspects of the invention is to correct deviation of a scanning direction of an ink landing position occurring between the nozzle row end portions and the nozzle row center portion when a ruled line is printed using an ink jet printer.

According to an aspect of the invention, there is provided a printing method of printing an image, in which, on a medium transported in a transport direction, while nozzle rows including a plurality of nozzles move in a scanning direction intersecting the transport direction, ink is ejected from the nozzles, and dots are formed to print an image. Coordinates of dots formed by nozzles of a nozzle row center portion and coordinates of dots formed by nozzles of nozzle row end portions are measured with respect to a ruled line printed in advance along the transport direction by ejecting ink from the plurality of nozzles, and an amount of deviation in the scanning direction among the coordinates is calculated. Pixel data corresponding to the dots formed by the nozzles of the nozzle row end portions among pixel data as data indicating unit elements forming an image are shifted in the scanning direction according to the amount of deviation, to perform printing.

Another aspect of the invention will be more clearly described with reference to the specification and accompanying drawings.

### BRIEF DESCRIPTION OF THE DRAWINGS

The invention will be described with reference to the accompanying drawings, wherein like numbers reference like elements.

FIG. 1 is a block diagram illustrating an overall configuration of a printing system.

FIG. 2A is a view illustrating a configuration of a printer of an embodiment.

FIG. 2B is a side view illustrating the configuration of the printer of the embodiment.

FIG. 3 is a cross-sectional view illustrating a structure of a head.

FIG. 4 is a diagram illustrating arrangement of nozzles of the head.

FIG. 5A is a diagram illustrating that ink dots are formed on a medium at the Uni-d printing time.

FIG. 5B is a diagram illustrating ink dots formed on the medium when ink ejection velocities Vm1 to Vm180 are regular at the Uni-d printing time.

FIG. 6A is a diagram illustrating that ink dots are formed on the medium at the Bi-d printing time.

FIG. 6B is a diagram illustrating ink dots formed on the medium when ink ejection velocities Vm1 to Vm180 are regular at the Bi-d printing time.

FIG. 7 is a diagram illustrating that ink dots are formed on the medium when ink is ejected from the nozzles at two ink ejecting velocities at the Uni-d printing time.

FIG. 8 is a diagram illustrating that a ruled line is printed by ink dots formed on the medium, when an ink ejecting velocity of ink ejected from nozzles of a nozzle row center portion is regular and an ink ejecting velocity of ink ejected from nozzles of nozzle row end portions is higher than that, at the Uni-d printing time.

FIG. 9 is a diagram illustrating that ink dots are formed on the medium when ink is ejected from the nozzles at two ink ejecting velocities at the Bi-d printing time.

FIG. 10 is a diagram illustrating that a ruled line is printed by ink dots formed on the medium, when an ink ejecting velocity of ink ejected from nozzles of a nozzle row center portion is regular and an ink ejecting velocity of ink ejected from nozzles of nozzle row end portions is higher than that, at the Bi-d printing time.

FIG. 11 is a flowchart for calculating an amount of deviation of ink dots.

FIG. 12 is a diagram illustrating an amount of deviation of ink dots and a reference line.

FIG. 13A is a diagram illustrating an example of pixel data for printing a ruled line.

FIG. 13B is a diagram illustrating disposition of dots formed on the basis of the pixel data shown in FIG. 13A.

FIG. 14A is a diagram illustrating pixel data obtained by correcting the pixel data shown in FIG. 13A.

FIG. 14B is a diagram illustrating disposition of dots formed on the basis of the pixel data shown in FIG. 14A.

### DESCRIPTION OF EXEMPLARY EMBODIMENTS

The followings will be clear by description of the specification and description of the accompanying drawings.

In a printing method of printing an image, on a medium transported in a transport direction, while nozzle rows including a plurality of nozzles move in a scanning direction intersecting the transport direction, ink is ejected from the nozzles, and dots are formed to print an image, coordinates of dots formed by nozzles of a nozzle row center portion and coordinates of dots formed by nozzles of nozzle row end portions are measured with respect to a ruled line printed in advance along the transport direction by ejecting ink from the plurality of nozzles, an amount of deviation in the scanning direction among the coordinates is calculated, and pixel data corresponding to the dots formed by the nozzles of the nozzle row end portions among pixel data indicating unit elements forming an image are shifted in the scanning direction according to the amount of deviation, to perform printing.

According to such a printing method, it is possible to correct the deviation in the scanning direction of the ink landing position occurring between the nozzle row end portions and the nozzle row center portion when the ruled line is printed.

In the printing method, it is preferable that the direction the pixel data is to be shifted in is a direction opposite to the direction in which the dots formed by the nozzles of the nozzle row end portions deviate from the dots formed by the nozzles of the nozzle row center portion.

According to such a printing method, it is possible to make the ruled line straight by shifting the pixels in the direction opposite to the deviation direction of the actually formed dots.

In the printing method, it is preferable that the time of ejecting ink from the plurality of nozzles is adjusted to land the ink ejected from the plurality of nozzles at the same position in the scanning direction on the medium when the ink is ejected while the nozzle rows moves in the scanning direction, and the ruled line is printed after the time is adjusted.

According to such a printing method, it is possible to suppress the deviation of the ruled line by correcting the deviation of the dot landing position which is caused by the difference of ink ejecting characteristics for each head and which occurs even after Bi-d (Uni-d) adjustment.

In the printing method, it is preferable that the pixel data are not shifted when the calculated amount of deviation in the scanning direction is smaller than a predetermined value.

According to such a printing method, the deviation of the ruled line from is prevented from greatly increasing by shifting the dots originally having a small amount of deviation and having no need to shift.

In the printing method, it is preferable that the amount of shifting of the pixel data increases as the calculated amount of deviation in the scanning direction becomes larger.

According to such a printing method, it is possible to correct the dot positions with high precision by determining how many pixels the pixel data is shifted by, according to the amount of deviation of actual dots, and it is possible to more efficiently prevent the deviation of the ruled line.

In the printing method, it is preferable that the coordinates of the dots formed by nozzles of the nozzle row center portion is determined by an average value in the scanning direction of the plurality of dots formed by the nozzles of the nozzle row center portion.

According to such a printing method, since the difference of the deviation between the dots and the reference line is reduced, the ruled line easily becomes straight when the pixel data is corrected to shift the end portion dot positions.

According to another aspect of the invention, there is provided a printing apparatus including: a head unit that has nozzle rows including a plurality of nozzles, moves in a scanning direction intersecting a transport direction of a medium, ejects ink from the nozzles, forms dots to print an image; and a control unit that generates image data for printing the image, wherein the control unit shifts pixel data corresponding to dots formed by nozzles of nozzle row end portions in the scanning direction among pixel data indicating unit elements forming the image, according to an amount of deviation in the scanning direction between coordinates of dots formed by nozzles of a nozzle row center portion and coordinates of the dots formed by the nozzles of the nozzle row end portions.

### Basic Configuration of Printing Apparatus

An ink jet printer (printer 1) will be described as an aspect of a printing apparatus for embodying the invention by way of example.

### Configuration of Printer

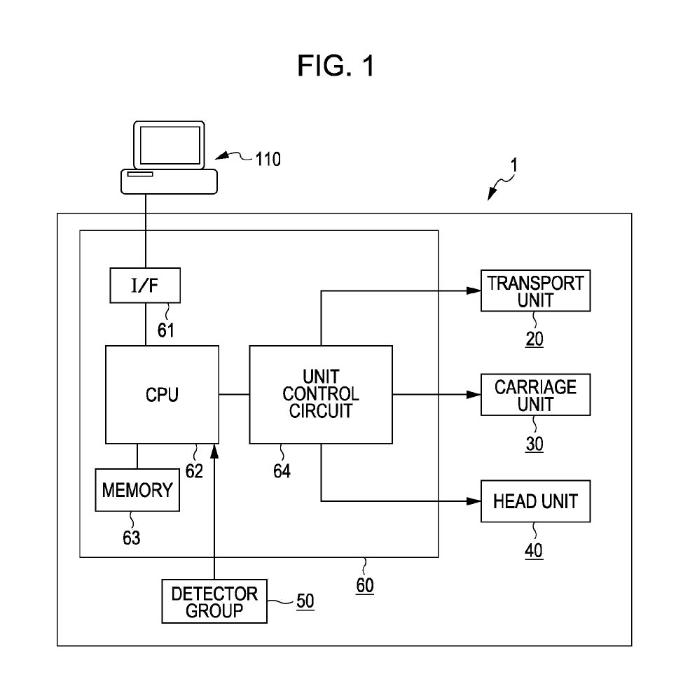

FIG. 1 is a block diagram illustrating an overall configuration of the printer 1.

The printer 1 is a liquid ejecting apparatus recording (printing) characters or images on a medium such as paper, cloth, and film, and is communicably connected to a computer 110 that is an external device.

A printer driver is installed in the computer 110. The printer driver is a program for causing a display device (not shown) to display a user interface to convert image data output from an application program into printing data. The printer driver is recorded on a recording medium (computer-readable recording medium) such as a flexible disk FD or a CD-ROM. The printer driver can be downloaded to the computer 110 through the Internet. The program includes codes for performing various functions.

The computer 110 outputs printing data corresponding to a printed image to cause the printer 1 to print the image.

The printer 1 has a transport unit 20, a carriage unit 30, a head unit 40, a detector group 50, and a controller 60. The controller 60 prints the image on the medium by controlling the units on the basis of the printing data received from the computer 110 that is an external device. The state in the printer 1 is monitored by the detector group 50, and the detector group 50 outputs a detection result to the controller 60. The controller 60 controls the units on the basis of the detection result output from the detector group 50.

### Transport Unit 20

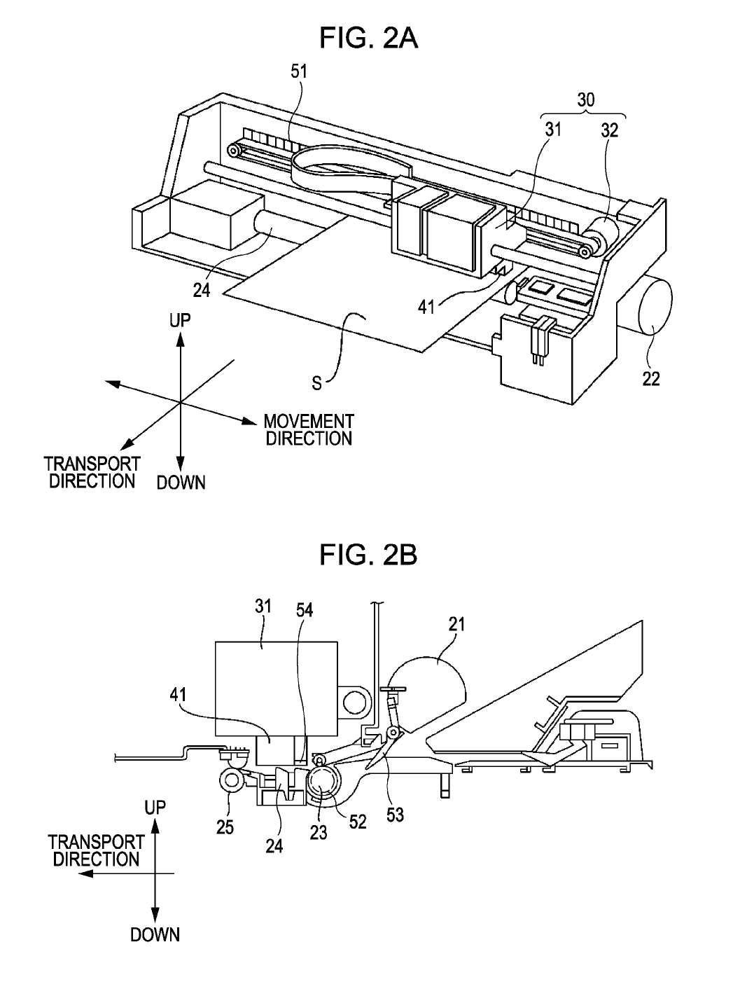

FIG. 2A and FIG. 2B are diagrams illustrating a configuration of the printer 1 according to the embodiment.

The transport unit 20 transports the medium (e.g., sheet S) in a predetermined direction (hereinafter, referred to as a transport direction). The transport direction is a direction intersecting a movement direction of the carriage. The transport unit 20 has a feed roller 21, a transport motor 22, a transport roller 23, a platen 24, and a discharge roller 25 (FIG. 2A and FIG. 2B).

The feed roller 21 feeds a sheet inserted into a sheet inserting port, into the printer. The transport roller 23 transports the sheet S fed by the feed roller 21 to a printable area, and is driven by the transport motor 22. Operation of the transport motor 22 is controlled by the controller 60 of the printer. The platen 24 is a member supporting the printing sheet S from the rear of the sheet S. The discharge roller 25 discharges the sheet S to the outside of the printer, and is provided on the downstream side of the transport direction in the printable area.

### Carriage Unit 30

The head unit 40 moves (scans) a mount carriage 31 of the carriage unit 30 in a predetermined direction (hereinafter, referred to as a movement direction). The carriage unit 30 has a carriage 31 and a carriage motor 32 (CR motor) (FIG. 2A and FIG. 2B).

The carriage 31 can go forward and backward in the movement direction, and is driven by the carriage motor 32. An operation of the carriage motor 32 is controlled by the controller 60 of the printer. The carriage 31 attachably and detachably holds an ink cartridge which accommodates ink.

### Head Unit 40

The head unit 40 ejects ink to the sheet S. The head unit 40 is provided with a head 41 having a plurality of nozzles. The head 41 is provided in the carriage 31. When the carriage moves in the movement direction, the head 41 also moves in the movement direction. The head 41 discontinuously ejects ink while moving in the movement direction. Then, a dot line (raster line) along the movement direction is formed on the sheet.

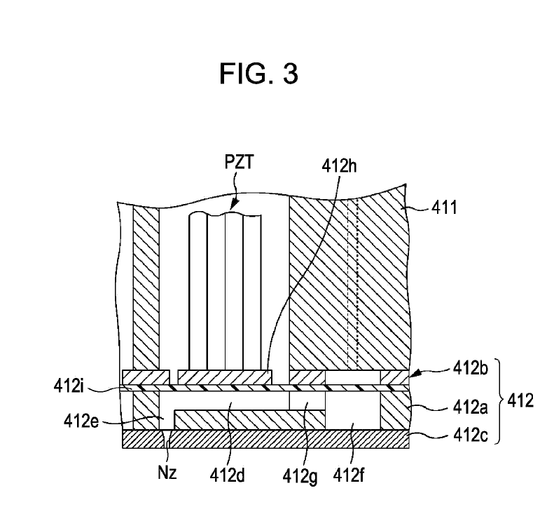

FIG. 3 is a cross-sectional view illustrating a structure of the head 41. The head 41 has a case 411, a flow path unit 412, and a piezoelectric element group PZT. The case 411 houses the piezoelectric element group PZT, and the flow path unit 412 is bonded to the lower face of the case 411. The flow path unit 412 has a flow path forming plate 412a, an elastic plate 412b, and a nozzle plate 412c. The flow path forming plate 412a is provided with a groove portion which becomes a pressure chamber 412d, a hole which becomes a nozzle communicating hole 412e, a hole which becomes a common ink chamber 412f, and a groove portion which becomes an ink supply path 412g. The elastic plate 412b has an island portion 412h to which a front end of the piezoelectric element PZT. An elastic area is formed around the island portion 412h by an elastic film 412i. Ink reserved in the ink cartridge is supplied to the pressure chamber 412d corresponding to each nozzle Nz through the common ink chamber 412f. The nozzle plate 412c is a plate in which the nozzles Nz are formed. On the nozzle face, a yellow nozzle row Y ejecting yellow ink, a magenta nozzle row M ejecting magenta ink, a cyan nozzle row C ejecting cyan ink, and a black nozzle row K ejecting black ink are formed. In each nozzle row, the nozzles Nz are arranged at a predetermined distance D in the transport direction.

The piezoelectric element group PZT has a plurality of comb-tooth shaped piezoelectric elements (driving elements) corresponding to the nozzles Nz. A driving signal COM is applied to the piezoelectric elements by a wiring substrate (not shown) on which a head control unit HC and the like are mounted, and the piezoelectric elements extend or contract up and down according to potential of the driving signal COM. When the piezoelectric elements PZT extend or contract, the island portion 412h is pushed toward the pressure chamber 412d or is pulled in the opposite direction. At this time, the elastic film 412i around the island portion 412h is deformed, and thus the pressure in the pressure chamber 412d increases or decreases, thereby ejecting ink droplets from the nozzles.

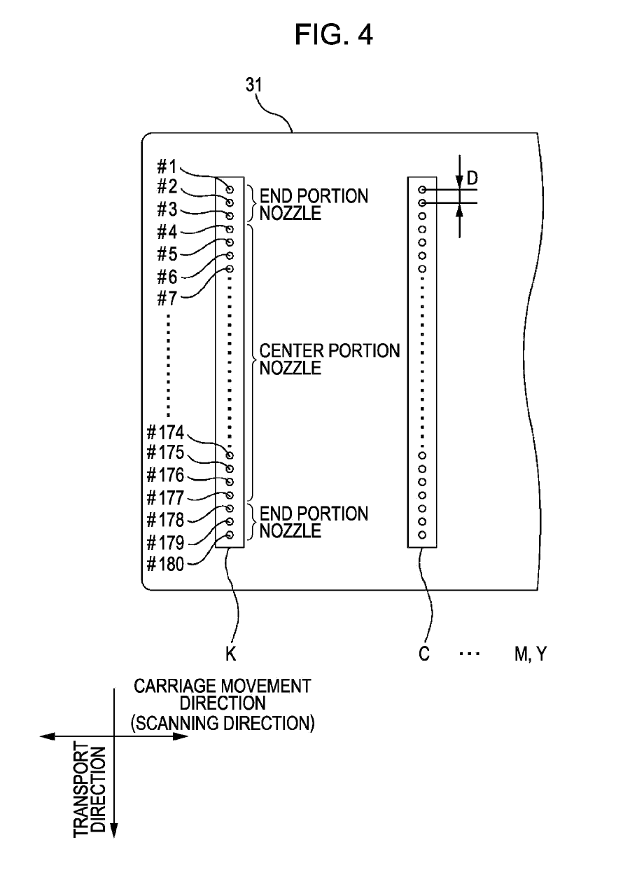

FIG. 4 is a diagram illustrating the nozzles Nz provided in the head 41. As shown in FIG. 4, in each nozzle row, the nozzles Nz that are ejection holes for ejecting each color of ink are arranged at a predetermined distance D in the transport direction. In the embodiment, each nozzle row is provided with 180 nozzles Nz of #1 to #180. Three nozzles of #1 to #3 and three nozzles of #178 to #180 are end portion nozzles of each nozzle row, and nozzles of #4 to #177 are center portion nozzles of the nozzle row.

The number of actual nozzles in each nozzle row is not limited to 180, and the number of nozzles may be, for example, 90 or 360. The number of nozzles of the nozzle row end portion is not limited to three from the end portion, and five nozzles (#1 to #5) from the end portion may be defined as the end portion nozzles. The number of end portion nozzles is determined by head characteristics caused by errors during production or the method by which ink flows in the head.

The piezoelectric element group has a plurality of piezoelectric elements PZT (driving elements) corresponding to the number of the nozzles. A driving signal COM is applied to the piezoelectric element PZT by a flexible cable (not shown) that is the wiring substrate, and the piezoelectric elements extend or contract up and down according to potential of the driving signal COM. When the piezoelectric elements PZT extend or contract, the island portion 412h shown in FIG. 3 is pushed toward the pressure chamber 412d or is pulled in the opposite direction. At this time, the elastic film 412i around the island portion 412h is deformed, and thus the pressure in the pressure chamber 412d increases or decreases, thereby ejecting ink droplets from the nozzles.

### Detector Group 50

The detector group 50 monitors the state of the printer 1. The detector group 50 includes a linear encoder 51, a rotary encoder 52, a sheet detecting sensor 53, an optical sensor 54, and the like (FIG. 2A and FIG. 2B).

The linear encoder 51 detects a position of the movement direction of the carriage 31. The rotary encoder 52 detection of rotation of the transport roller 23. The sheet detecting sensor 53 detects the position of the front end of the fed sheet S. The optical sensor 54 detects whether or not there is the sheet S at the opposed position using a light emitting unit and a light receiving unit mounted on the carriage 31; for example, it detects the positions of the end portions of the sheet during movement, thereby detecting the width of the sheet. The optical sensor 54 can detect the front end (the end portion on the downstream side of the transport direction, and the upper end) and the rear end (the end portion on the upstream side of the transport direction, and the lower end) of the sheet S.

### Controller 60

The controller 60 is a control unit for controlling the printer. The controller 60 has an interface unit 61, a CPU 62, a memory 63, and a unit control circuit 64.

The interface unit 61 performs transmission and reception of data between the computer 110 that is an external device and the printer 1. The CPU 62 is an operation processing device for controlling the whole printer 1. The memory 63 secures an area for storing the program of the CPU 62 or a work area, and is including a storage device such as a RAM or an EEPROM. The CPU 62 controls the units such as the transport unit 20 through the unit control circuit 64 according to the program stored in the memory 63.

### Printing Process by Printer Driver

The printer driver receives image data from the application program, converts the image data into printing data of a format capable of being analyzed by the printer 1, and outputs the printing data to the printer. When the image data is converted from the application program into the printing data, the printer driver performs a resolution conversion process, a color conversion process, a half-tone process, a rasterizing process, a command adding process, and the like. Hereinafter, various processes performed by the printer driver will be described.

The resolution conversion process is a process of converting the image data (text data, image data, etc.) output from the application program into a resolution (printing resolution) at the time of printing on the medium. For example, when the printing resolution is designated as 720×720 dpi, the image data of a vector type received from the application program is converted into image data of a bitmap type of a resolution of 720×720 dpi.

The pixel data of the image data after the resolution conversion process is RGB data of gradations (e.g., 256 gradations) indicated by RGB color space. The pixel is a unit element forming an image, and the pixels are 2-dimensionally arranged to form the image. The pixel data is printing data of the unit elements forming the image, and means, for example, gradation values of dots formed on the sheet S.

The color conversion process is a process of converting the RGB data into data of the CMYK color space. The image data of the CMYK color space is data corresponding to the colors of ink of the printer. The color conversion process is performed on the basis of a table (color conversion look-up table LUT) in which the gradation values of the RGB data are associated with the gradation values of CMYK data.

The pixel data after the color conversion process is 8-bit CMYK data of 256 gradations indicated by the CMYK color space. In the embodiment, the image process is performed using the data, and bleeding of ink at the boundary portion of two images is prevented. Details of the image process will be described later.

The half-tone process is a process of converting data of the number of high gradations into data of the number of gradations which can be formed by printer. For example, the data indicating 256 gradations is converted into 1-bit data indicating 2 gradations or a 2-bit data indicating 4 gradations by the half-tone process. In the half-tone process, a dither method, a γ-correction/error diffusion method, and the like are used. The resolution of the half-tone processed data is equivalent to the printing resolution (e.g., 720×720 dpi). In the image data after the half-tone process, pixel data of 1-bit or 2-bit corresponds to each pixel, and the pixel data is data indicating a dot forming state (existence of dot and size of dot) in each pixel.

In the rasterizing process, pixel data arranged in matrix is sequentially changed in order of transmission to the printer 1 for each item of pixel data. For example, the pixel data is sequentially changed according to line order of each nozzle row.

The command adding process is a process of adding command data according to the printing method to the rasterizing-processed data. An example of the command data includes transport data indicating a transport velocity of the medium.

The printing data generated by such processes is transmitted to the printer 1 by the printer driver.

### Printing Operation of Printer

A printing operation of the printer 1 will be briefly described. The controller 60 receives a printing command from the computer 110 through the interface unit 61, and controls the units, thereby performing a feed process, a dot forming process, a transport process, and the like.

The feed process is a process of supplying a printing sheet into the printer, and positioning the sheet at a printing start position (referred to also as a head poke position). The controller 60 rotates the feed roller 21 to send the printing sheet to the transport roller 23. Subsequently, the sheet sent from the feed roller 21 by rotating the transport roller 23 is positioned at the printing start position.

The dot forming process is a process of discontinuously ejecting ink from the head moving along the movement direction (scanning direction) to form dots on the sheet. The controller 60 moves the carriage 31 in the movement direction to eject ink from the head 41 on the basis of the printing data while the carriage 31 moves. When the ejected ink droplets lands on the sheet, the dots are formed on the sheet, and a dot line including the plurality of dots along the movement direction is formed on the sheet.

The transport process is a process of relatively moving the sheet along the transport direction with respect to the head. The controller 60 rotates the transport roller 23 to transport the sheet in the transport direction. By the transport process, the head 41 can form dots at a position other than that of the dots formed at the immediately preceding time by the dot forming process.

The controller 60 alternately repeats the dot forming process and the transport process until the data to print runs out, and gradually prints an image including the dot lines on the sheet. When the data to print runs out, the controller 60 rotates the discharge roller to discharge the sheet. Whether or not to discharge the sheet may be determined on the basis of a discharge command forming the printing data.

When the printing is performed on the next sheet, the same processes are repeated, otherwise the printing operation ends.

### Printing of Ruled Line

First, a method of printing a ruled line using the printer 1 will be described.

In the printing operation, the movement velocity in the scanning direction of the head 41 provided in the carriage 31 is defined as “Vc”, and the velocity of ink ejected from the nozzles Nz provided in the head 41 is defined as “Vm”. For description, it is assumed that the movement velocity Vc of the carriage is always regular, and the ink ejecting velocity Vm is Vm1 to Vm180 for the nozzles Nz of #1 to #180 forming each color nozzle row.

As a printing method, there are a uni-direction printing method (hereinafter, referred to as a Uni-d method) of ejecting ink to form an image only when the head 41 moves from one end side to the other end side in the scanning direction, and a bi-direction printing method (hereinafter, referred to as a Bi-d method) of ejecting ink on the forward path and the backward path to form an image while the head 41 moves forward and backward between one end side and the other end side.

### When Ink Ejecting Velocity Vm is Regular in all Nozzles Nz of Nozzle Row

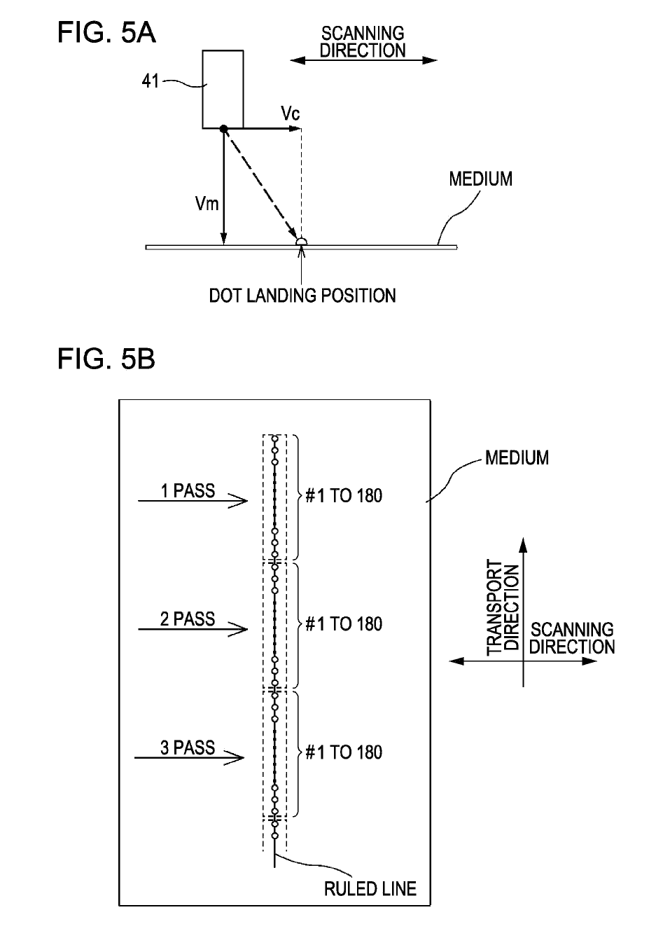

FIG. 5A is a diagram illustrating that ink dots are formed on the medium at the Uni-d printing time. FIG. 5B is a diagram illustrating a ruled line printed by ink dots formed on the medium when the ink ejecting velocities Vm1 to Vm180 are regular with respect to all the nozzles Nz of #1 to #180 forming each nozzle row at the Uni-d printing time.

In the Uni-d printing, the head 41 ejects ink vertically downward on the medium at the velocity Vm while moving from one end side to the other end side (from left to right in FIG. 5A) in the scanning direction at the regular velocity Vc. The ejected ink obliquely flies onto the medium, and lands on the medium to form dots. Whenever, the head 41 moves (passes) from one end side to the other end side in the scanning direction once, ink is simultaneously ejected from all the nozzles Nz (#1 to #180) of the nozzle row.

When the ink ejecting velocity Vm is regular with respect to all the nozzles Nz and the ink ejection time is the same, the landing positions of the ink ejected from the nozzles Nz of #1 to #180 are the same position with respect to the scanning direction, and an ink dot row extending in the transport direction is formed (see FIG. 5B). After the ink dot row for the first pass is formed, the medium is transported to the downstream side, and subsequently ink for the second pass is ejected to form an ink dot row for the second pass on the upstream side of the transport direction for the first pass. By repeating such an operation, a ruled line (straight line) including the dot row is printed on the medium.

The ink ejection time is designed in a design process such that ink is ejected from a front position opposed to a target position where ink lands, as shown in FIG. 5A. That is, the ink ejection time is designed such that ink is ejected at the time earlier than the time when the head 41 moves in the scanning direction and a predetermined nozzle reaches a position opposed to a target position by the time when ink is ejected from a predetermined nozzle and then the ink lands on the medium.

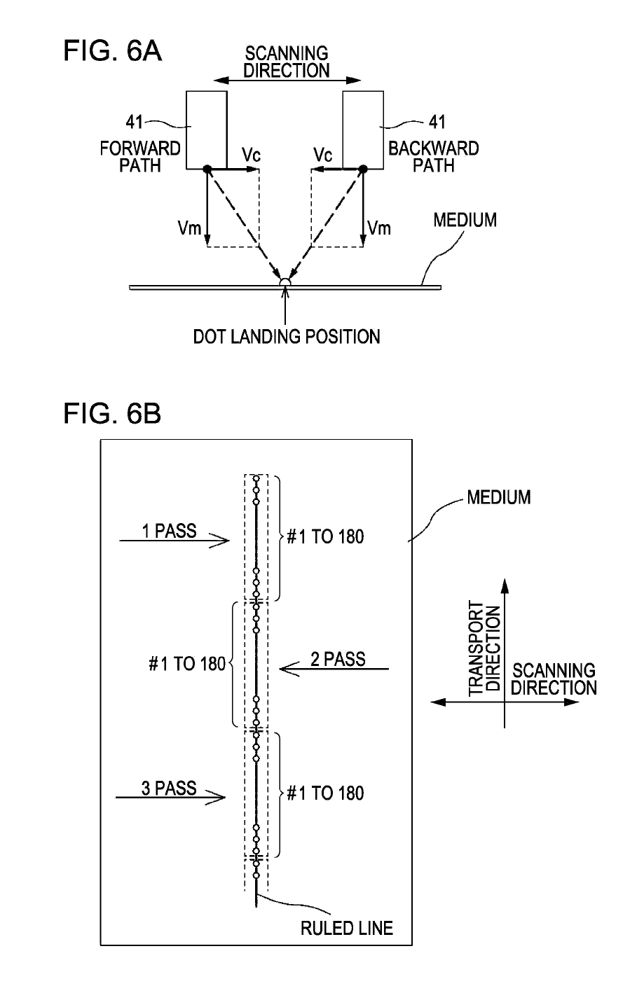

FIG. 6A is a diagram illustrating that ink dots are formed on the medium at the Bi-d printing time. FIG. 6B is a diagram illustrating that the ruled line is printed by ink dots formed on the medium when the ink ejecting velocities Vm1 to Vm180 are regular with respect to all the nozzles Nz of #1 to #180 forming each nozzle row at the Bi-d printing time.

The operation on the forward path of the Bi-d printing is the same as the operation at the above-described Uni-d printing time. That is, the head 41 ejects ink vertically downward on the medium at the velocity Vm while moving from left to right in the scanning direction at the regular velocity Vc. The ejected ink obliquely flies onto the medium, and lands on the medium to form dots. In the backward path, the head 41 ejects ink vertically downward on the medium at the velocity Vm while moving from right to left in the scanning direction at the regular velocity Vc (see FIG. 6A). At this time, on the forward path and the backward path, it is possible to control the ink landing position to the medium by adjusting the time of ejecting the ink from the nozzles Nz. Accordingly, as shown in FIG. 6B, the dot rows are formed at the same position in the scanning direction in the first pass (forward path) and the second pass (backward path), and thus the ruled line with no deviation can be printed by repeating the forming.

### When Ink Ejecting Velocity Vm is not Regular

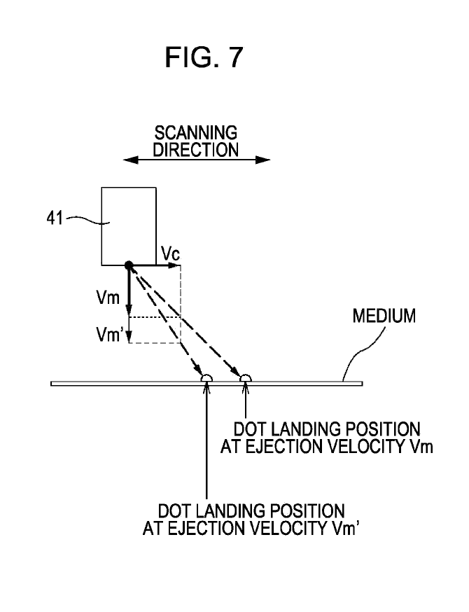

FIG. 7 shows that ink dots are formed on the medium when ink is ejected from the nozzles at two kinds of ink ejecting velocities of “Vm” and “Vm′” higher than the Vm, at the Uni-d printing time. The Vc is regular, but the Vm′ is higher than the Vm. Accordingly, the ink ejected from the nozzles Nz at the velocity of Vm′ lands on the medium, earlier than the ink ejected from the nozzles Nz at the velocity Vm. Accordingly, as shown in FIG. 7, the ink dots ejected at the velocity Vm′ lands further to the front side in the scanning direction than the landing position of the ink dots ejected at the velocity Vm.

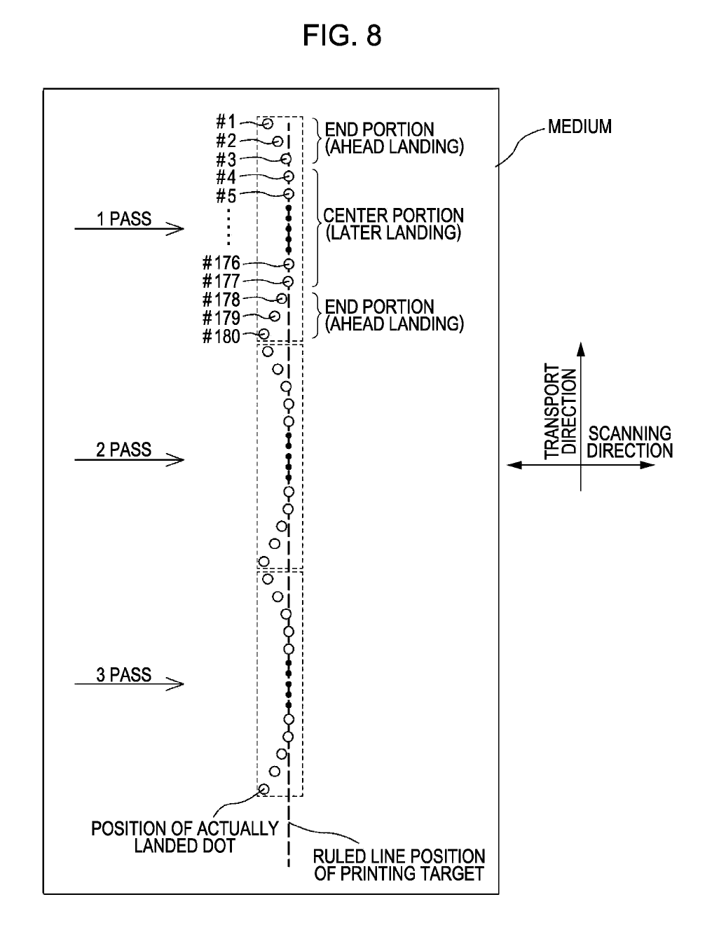

FIG. 8 is a diagram illustrating that the ruled line is printed by ink dots formed on the medium when the velocities Vm4 to Vm177 of ink ejected from the center portion nozzles (#4 to #177) of the nozzle row are regular and the velocities Vm1 to Vm3 and Vm178 to Vm180 of ink ejected from the end portion nozzles (#1 to #3 and #178 to #180) of the nozzle row are higher than Vm4 to Vm177, at the Uni-d printing time.

As described above, when the printing is performed by the printer 1, ink flows through the flow path unit 412 in the head 41 and is ejected from the nozzles Nz. At the printing time, it is not limited that the ink uniformly flows in the head and the ink is always equally ejected from all the nozzles Nz, and there are cases where deflection in ink flow may occur in the flow path unit 412. Particularly, there are many cases where ink excessively flows into the end portion nozzles Nz (#1 to #3 and #178 to #180) of each nozzle row, or on the contrary, hardly flows. Accordingly, there is a case where a difference in ink ejection characteristics occurs between the center portion nozzles (#4 to #177) and the end portion nozzles (#1 to #3 and #178 to #180) of the nozzle row. FIG. 8 shows an influence on the ruled line printing when the ink ejection velocity of the end portion nozzles is higher than that.

As described with reference to FIG. 7, when the ejection velocity of the ink ejected from the nozzles Nz is high, the ink is apt to land early on the medium. Accordingly, as shown in FIG. 8, the ink ejected from the end portion nozzles (#1 to #3 and #178 to #180) lands on the medium earlier than the ink ejected from the center portion nozzles (#4 to #177), and ink dots are formed further to the front side (the left side in the scanning direction in FIG. 7) in the scanning direction than the ruled line position to be printed. Since the ink ejection velocity is changed in order of Vm1→Vm2→Vm3→Vm4, FIG. 8 shows that the ink ejected from the endmost nozzle #1 of the nozzle row earliest lands on the medium, and subsequently, the ink lands in order of #2, #3, and #4. Meanwhile, ink is ejected from the center portion nozzles (#4 to #177) at a regular velocity, and ink dots land onto the prearranged scanning direction position (the ruled line position).

Accordingly, while the head 41 moves once from left to right in the scanning direction in the first pass, the dot row formed by the center portion (#4 to #177) of the nozzle row becomes a straight line, and the dot rows formed by the end portions (#1 to #3 and #178 to #180) of the nozzle row become arc-shaped curved lines. Since the same shape is formed in the second pass and the third pass, it is difficult to straightly print the ruled line.

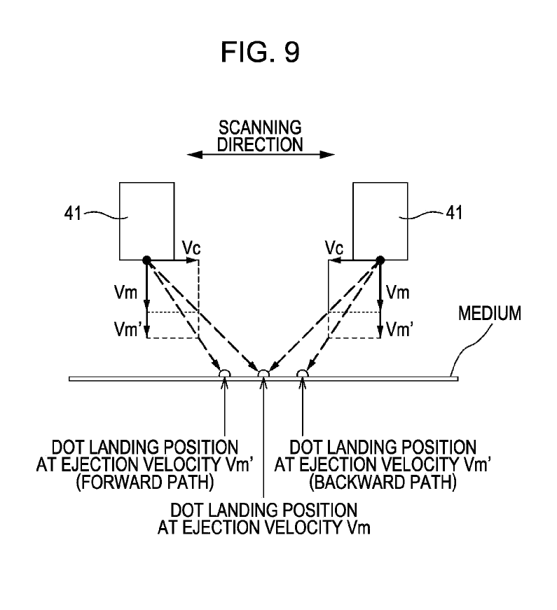

FIG. 9 shows that ink dots are formed on the medium when ink is ejected from the nozzles at two kinds of ink ejecting velocities of “Vm” and “Vm′” higher than the Vm, at the Bi-d printing time. Similarly to the Uni-d printing time, since the Vm′ is higher than the Vm. Accordingly, the ink ejected from the nozzles Nz at the velocity Vm′ lands on the medium, earlier than the ink ejected from the nozzles Nz at the velocity Vm. Accordingly, the ink dots ejected on the forward path at the velocity Vm′ land further to the front side (the left side in the scanning direction in FIG. 9) than the landing position of the ink dots ejected at the velocity Vm, and the ink dots ejected on the backward path at the velocity Vm′ land further to the front side (the right side in the scanning direction in FIG. 9) than the landing position of the ink dots ejected at the velocity Vm.

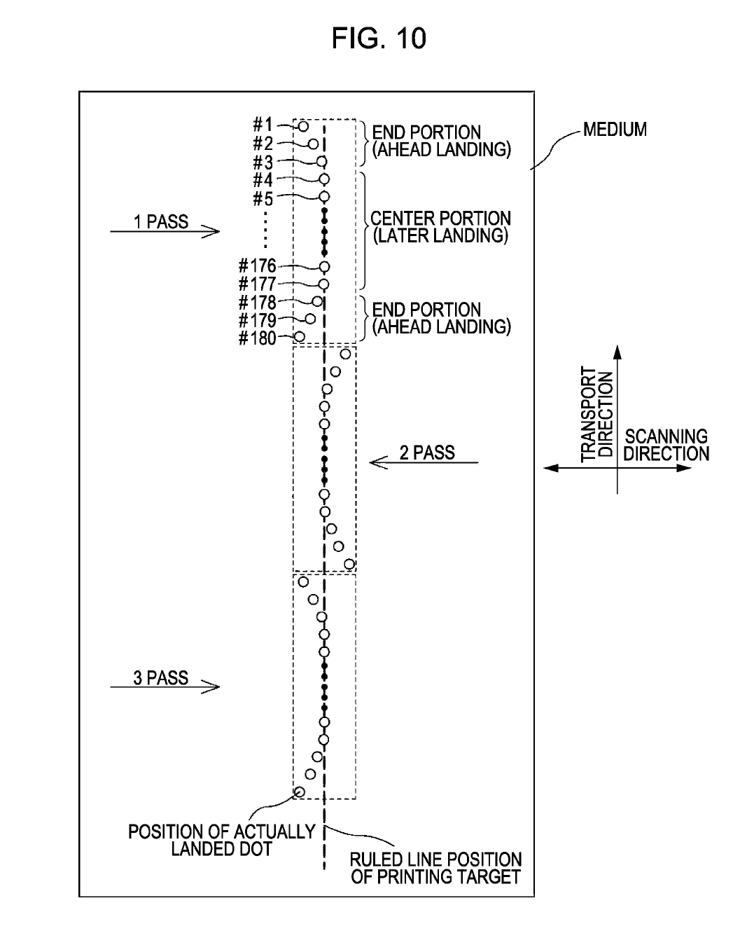

FIG. 10 is a diagram illustrating that the ruled line is printed by ink dots formed on the medium when the velocities Vm4 to Vm177 of ink ejected from the center portion nozzles (#4 to #177) of the nozzle row are regular and the velocities Vm1 to Vm3 and Vm178 to Vm180 of ink ejected from the end portion nozzles (#1 to #3 and #178 to #180) of the nozzle row are higher than Vm4 to Vm177, at the Bi-d printing time.

Similarly to the Uni-d printing time also in this case, the ink ejected from the end portion nozzles (#1 to #3 and #178 to #180) lands on the medium earlier than the ink ejected from the center portion nozzles (#4 to #177), and ink dots are formed further to the front side in the scanning direction than the ruled line position to be printed. Accordingly, while the head 41 moves once from left to right in the scanning direction on the forward path of the first pass, the dot row formed by the center portion (#4 to #177) of the nozzle row becomes a straight line, and the dot rows formed by the end portions (#1 to #3 and #178 to #180) of the nozzle row become arc-shaped curved lines. On the backward path of the second pass, the dot rows become line curved in the reverse direction to the direction of the first pass.

In the Bi-d printing, since the head 41 ejects ink while moving forward and backward, the dot formed by the nozzle #180 in the first pass is formed on the left side from the ruled line position, and the dot formed by the nozzle #1 in the second pass is formed on the right side from the ruled line position. Accordingly, an amount of deviation in the scanning direction of both dots becomes large. That is, deviation of a boundary line between the first pass and the second pass gets larger than that at the Uni-d printing time, and deterioration of the printed image is drastically presented.

The case where the ink ejection velocity of the nozzles of the nozzle row end portions is high has been described above. On the contrary, a case where the ink ejection velocity of the nozzles of the nozzle row end portions is low is the same. As the ink ejection velocity is low, the time to when the ink ejected from the nozzles Nz lands on the medium extends. Accordingly, the ink dots land far away from the position to land (the position of the ruled line). As a difference in ink ejection velocity between the center portion nozzle Nz and the end portion nozzles Nz of the nozzle row gets larger, the deviation of the ink dot landing positions in the scanning direction gets larger, and thus it is difficult to straightly print the ruled line.

### Correction of Deviation at Ruled Line Printing Time

As described above, there is the case where the deviation occurs at the landing position in the scanning direction of the ink dots by the ink ejection characteristics generated for each nozzle Nz of the nozzle row. When such deviation occurs, it is difficult to straightly print the ruled line. Thus, in the embodiment, deviation of the ink dot landing position is predicted, the pixel data used for printing is corrected in advance, and the formation prearrangement position in the scanning direction of the dots are shifted. Accordingly, at the actual printing time, the deviation from the scanning direction position (the position of the ruled line) to print is reduced and the ink dots are caused to land.

### Measurement of Deviation

To perform the correction of the pixel data, first, a ruled line as a test pattern is printed using the nozzles used in printing. In the test pattern, an amount of deviation between the position of the ruled line to print and the ink dot position actually formed by ink ejected from the nozzles Nz (#1 to #180) of the nozzle row is calculated.

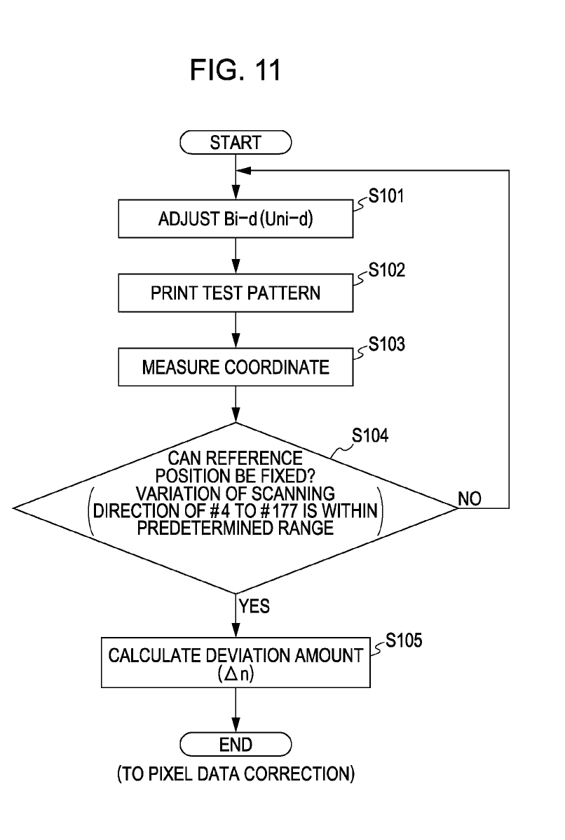

FIG. 11 shows a flowchart for calculating the amount of deviation of the ink dots. Processes shown in the flowchart are performed in a production step of the printer 1, and are not performed at the printing time by a user.

### S101: Bi-d (Uni-d) Adjustment

First, Bi-d adjustment (or Uni-d adjustment) of the printer 1 is performed (S101). The Bi-d adjustment is to adjust the time of ejecting ink from the nozzles Nz on the forward path and the backward path when the head 41 moves in the scanning direction. Accordingly, the dot formation position on the forward path and the dot formation position in the scanning direction coincide with each other in the state shown in FIG. 6B.

In addition to the ink ejection velocity Vm described above, the landing position of the ink dots may deviate on the forward path and the backward path by an influence of the head movement velocity Vc or individual difference of printer heads. For example, in FIG. 6A, when the actual head movement velocity Vc is lower than the designed head movement velocity, the ink dots land further to the front side in the scanning direction than the position to land (the position of the ruled line) on both the forward path and the backward path. In such a case, it is possible to arrange the dot formation positions during forward and backward movement by delaying the ink ejection time later than the designed time.

In the embodiment, it is possible to correct deviation of the dot landing position in the scanning direction caused by ejection characteristic difference of the nozzles Nz (#1 to #180), which further occurs even after performing the Bi-d adjustment (or Uni-d adjustment).

### S102 and S103: Test Pattern Printing and Coordinate Measurement

A ruled line as a test pattern is printed using the printer in which the Bi-d adjustment is completed (S102). The printed test pattern is observed using a microscope, to measure and record coordinates of the dots formed by 180 nozzles Nz of #1 to #180 (S103). Particularly, coordinates in the scanning direction of the end portion nozzles (#1 to #3 and #178 to #180) of the nozzle row in which the landing position of the ink dots easily deviates are necessarily recorded. Meanwhile, As for the center portion nozzles (#4 to #177) of the nozzle row in which the landing position deviation of dots is relatively small, coordinates of all the dots are measured, but a predetermined number of parts may be selected and recorded by sampling measurement. Whether to perform full measurement or to perform the sampling measurement by viewing the actually printed test pattern may be determined according to whether the ruled line is relatively straightly printed or curved. When the ruled line of the test pattern has an overall curve, it is preferable to perform the full measurement.

The measurement method of the dot coordinates is not limited to observation using a microscope, and may be performed by laser measurement.

### S104: Confirmation of Reference Position

Subsequently, a position (reference line) that is reference for calculating the amount of deviation of the dots is confirmed (S104). The reference position is a position where the ruled line is to be printed, and ink ejected from the nozzles Nz generally lands on the reference position to straightly form a ruled line (see FIG. 5B and FIG. 6B). Particularly, the ink dots ejected from the center portion nozzles (#4 to #177) of the nozzle row may be arranged in a substantially straight line after the Bi-d adjustment (or Uni-d adjustment) of S101. Accordingly, when the coordinates of the dots formed by the center portion nozzles (#4 to #177) of the nozzle row measured in S103 and the deviation in the scanning direction falls within a predetermined range, an average of the scanning direction positions is set as the reference position (reference line), and the coordinate in the scanning direction of the reference position is considered as 0.

For example, when ten coordinate points of the ink dots formed by the center portion nozzles of the nozzle row in S103 are measured by sampling and the ten coordinate points fall within a width of 0.07 mm (360 dpi), an average coordinate position of the ten points is set as the reference position (ruled line position). By taking the average, the deviation width between the dot positions of the center portion of the nozzle row and the ruled line position becomes small. Accordingly, when the correction of shifting the end portion dots of the nozzle row later, the deviation between the center portion dots of the nozzle row and the end portion dots of the nozzle row is reduced, and thus it is possible to overall straightly print the ruled line.

When the scanning direction coordinates of the dots are irregular and cannot be confirmed as the reference position, the Bi-d adjustment is performed again (S101).

### S105: Calculation of Amount of Deviation

After the reference line is confirmed, the amount of deviation in the scanning direction between the position of the reference line and the ink dots formed by the end portion nozzles (#1 to #3 and #178 to #180) of the nozzle row is calculated.

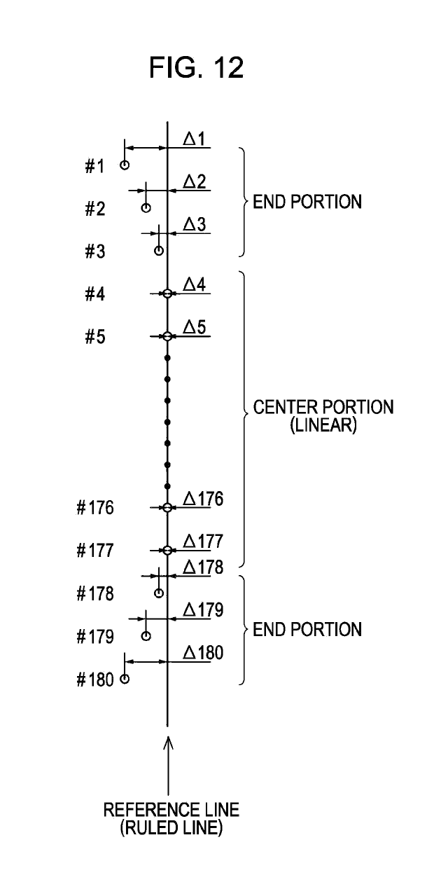

FIG. 12 is a diagram illustrating the amount of deviation of the ink dots and the reference line. A difference between the scanning direction coordinates of the dots and the scanning direction coordinate (0) of the reference line is represented by Δn (n=1, 2, 3, . . . , 180) and is stored in the memory 63 of the controller 60. The printer 1 is shipped in this state, and the deviation of the ruled line at the printing time is suppressed by correcting pixel data to be described later, in a step where the user performs printing using the printer 1 at home or the like.

In addition, the amount of deviation in the scanning direction for the all the dots, the coordinates of which are measured in S103, may be calculated. However, after the process of S104, the deviation amounts (Δ4 to Δ177) of the dots formed by the center portion nozzles (#4 to #177) are negligible sizes. Accordingly, the amount of deviation of the center portion is not necessarily calculated.

In the embodiment, it is assumed that the deviation of #1 to #3 and #178 to #180 of the nozzle row end portions is particularly large, and the description will be described paying attention to the ink dots at these parts.

### Pixel Data Correction

To actually perform the printing by the user, pixel data corresponding to the dots formed by the end portion nozzles (#1 to #3 and #178 to #180) of the nozzle row is corrected on the basis of the amount of deviation Δn of the ink dots stored in the memory 63. The pixel is a unit element forming an image, and the pixels are 2-dimensionally arranged to form the image. The pixel data is printing data of unit elements forming an image, and means, for example, gradation values of dots formed on the sheet S.

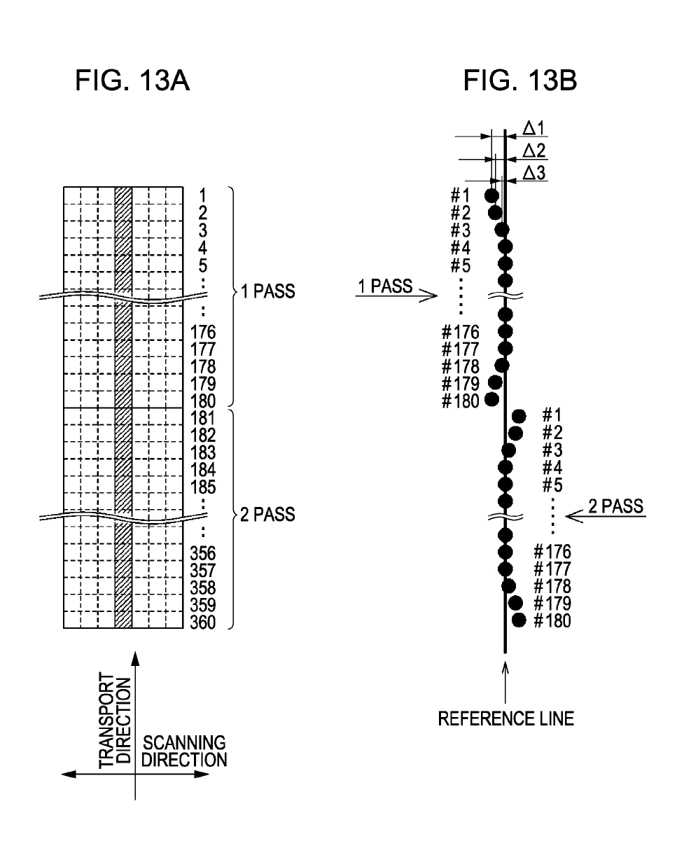

FIG. 13A shows an example of pixel data (before correction) for printing the ruled line. In FIG. 13A, one mass cut by dashed lines is one pixel, and dots of oblique line portions indicate pixels on which dots are to be formed. In FIG. 13A, the description is performed paying attention to data of 7×360 pixels around parts at which the ruled line is to be formed, but the actual pixel data is lager than that. FIG. 13B shows disposition of dots formed on the basis of the pixel data. In FIG. 13B, parts represented by indicate ink dots actually formed on the medium.

On the pixel data of FIG. 13A, all the pixels of dot formation prearrangement are arranged in a straight line in the transport direction without deviation in the scanning direction. Accordingly, ideally, it is natural that the printed ruled line is also straightly formed without deviation in the scanning direction. However, there are many cases where ink dots actually landing onto the medium deviate in the scanning direction, and thus there is a case where the deviation amount Δ1 to Δ3 and Δ178 to Δ180 at the nozzle row end portions (#1 to #3 and #178 to 180) become non-negligible sizes as described above. Particularly, at the Bi-d printing time, deviation of the boundary line of the first pass and the second pass is visible, which becomes an important factor of image deterioration (see FIG. 13B).

Thus, the pixel data is shifted in the reverse direction to the landing deviation direction of the dot according to the amount of deviation Δn for each nozzle Nz. For example, in FIG. 13B, the dots formed by the nozzles Nz of #1 and #2 are formed to be shifted to the left side of the reference line. The deviation amounts Δ1 and Δ2 of the dots are non-negligibly large, which causes the ruled line deviation. Accordingly, the pixel data forming the dots is corrected to change the dot landing position. In this case, the pixel data corresponding to #1 and #2 is shifted by one pixel to the right (the reverse direction to the landing deviation direction of the dots), and then the printing is performed.

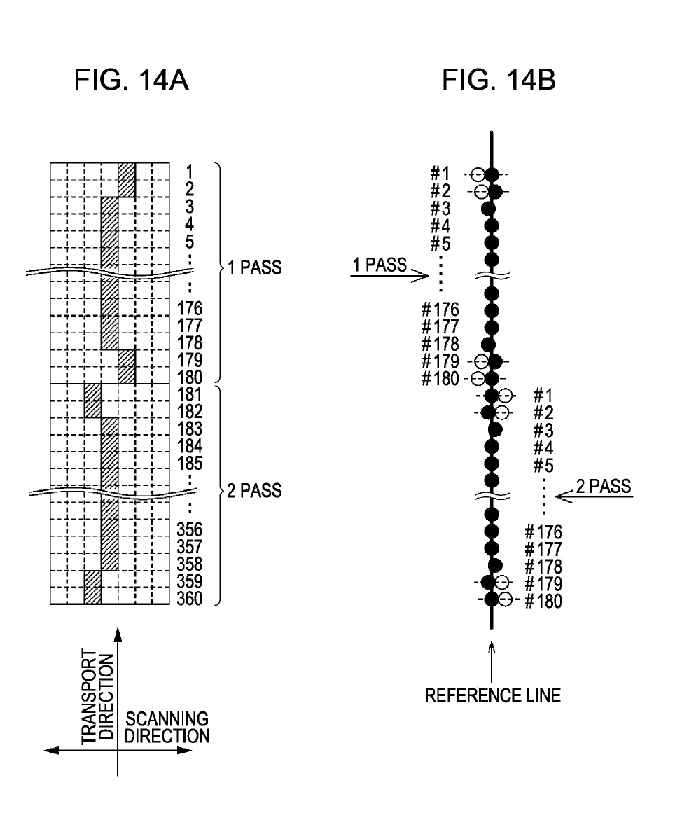

FIG. 14A shows the pixel data obtained by correcting the pixel data shown in FIG. 13A. FIG. 14B shows disposition of the dots formed on the basis of the pixel data after the correction.

In FIG. 14A, since the pixels corresponding to #1 and #2 with large deviation of the dot landing position are shifted by one pixel in the scanning direction, the actually landing dots are also shifted by one pixel. As a result, the dots of #1 and #2 which are obviously formed at the positions of ∘ shown in FIG. 14B according to the pixel data before the correction are formed at the positions. Accordingly, it is possible to decrease the deviation amounts Δ1 and Δ2 in the scanning direction from the reference line. Similarly, also as for the nozzle Nz of #179 and the nozzle Nz of #180 positioned at the nozzle row end portion, the correction of shifting the pixel data by one pixel is performed, and thus it is possible to print a ruled line with deviation smaller than that of the ruled line before the correction.

In the Bi-d printing, since the movement direction of the head 41 is reversed in the first pass and the second pass, the direction of shifting the pixel data is reversed (see FIG. 14A). Accordingly, the deviation of the boundary of the first pass and the second pass is made invisible, and the deviation of the ruled line is drastically reduced.

At the time of the pixel data correction, how much which pixels are to be shifted can be determined, on the basis of the amount of deviation Δn from the reference line of the dots formed by the pixel data before the correction. In the embodiment, when the dot amount of deviation Δn is smaller than a predetermined value, the correction of the pixel data is not performed, and the correction amount of the pixel data is made larger as the Δn gets larger.

For example, in a case of 0.035 mm (720 dpi)>Δn, the pixel of #n is not shifted. In a case of 0.07 mm>Δn≧0.035 mm, the pixel of #n is shifted by one pixel in the scanning direction. In a case of Δn≧0.07 mm, the pixel of #n is shifted by two pixels in the scanning direction. Such settings are stored in the memory 63. The settings are applied to the Δn measured in S105, thereby determining the shift amount for each pixel. The setting values may be appropriately changed according to the resolution (720×720 dpi. etc.) of the printed image.

In FIG. 14A, the amount of deviation of the dot of #3 is smaller than that of Δ1 or Δ2. When the pixel data of the dot of #3 is shifted, the deviation from the reference line rather becomes large. Accordingly, in such a case, the correction of the pixel data is not performed. Meanwhile, when the pixel data for Δ1 and Δ2 is shifted by two pixels, the deviation from the reference line also becomes large. Accordingly, the correction of shifting by one pixel is performed on #1 and #2. As described above, the amount of deviation as the reference is set, and thus it is possible to appropriately perform the correction of the pixel data. In addition, it is determined by how many pixels the pixel data is shifted by, according to the size of the amount of deviation Δn, and thus it is possible to correct the pixel data with higher precision.

After the pixel shifting amount is determined, the pixel data is actually corrected by the printer driver. The correction of the pixel data is performed between the half-tone process and the rasterizing process when the user performs the printing. Ink is ejected from the nozzles Nz on the basis of the data after the correction to perform the printing.

### SUMMARY

In the embodiment, first, the head unit ejects ink while moving in the scanning direction, and the ruled line extending in the transport direction is printed as the test pattern using the printer performing the printing. Since the deviation occurs in the scanning direction between the formation position of the ink dots formed by the nozzle row end portions of the head unit and the formation position of the dots formed by the nozzle row center portion, the amount of deviation is measured, the correction of shifting the corresponding pixels is performed on the pixel data according to the amount of deviation, and then the printing is performed.

Accordingly, it is possible to straightly print with a small amount of deviation.

The correction of the pixel data is performed after the Bi-d adjustment (or Uni-d adjustment) of adjusting the ink ejection time is performed.

The deviation of the dot landing position caused by the deviation of the ink ejection time is resolved by the Bi-d (Uni-d) adjustment, but there is a case where the dot landing position further deviates according to the difference of the ink ejection characteristics of the end portions and the center portion of the nozzle row. In the embodiment, it is possible to also correct the dot deviation occurring after such Bi-d (Uni-d) adjustment.

In the embodiment, the amount of deviation of the dots is compared with a predetermined setting value. When the amount of deviation is smaller than the setting value, the correction of the pixel data is not performed, and the dot deviation is prevented from being large unexpectedly by the data correction.

The amount of shifting the dots on the pixel data is changed according to the size of the amount of deviation of the dots. For example, the pixel shifting amount is made larger as the dot amount of deviation gets larger. In such a manner, the precise correction is performed according to the ink ejection characteristics of the head, and thus it is possible to more effectively suppress the ruled line deviation.

The position that is the reference when measuring the deviation of the dots is determined by an average of a plurality of dot coordinates formed by the nozzle row center portion.

Accordingly, the deviation between the dots and the reference line becomes small, and it is easy to straightly print the ruled line.

### Other Embodiments

The printer or the like has been described as an embodiment, but the embodiment is to make the invention easily understood, and is not to restrictively analyze the invention. The invention can be modified and improved within the concept thereof, and obviously includes equivalent materials thereof. Particularly, the invention includes the following embodiments.

### Printing Apparatus

In the embodiment, the ink jet printer has been described as an example of a printing apparatus forming an image, but the invention is not limited thereto. For example, the technique such as the embodiment may be applied to various kinds of liquid ejecting apparatuses applying the ink jet technology such as a color filter producing apparatus, a dyeing apparatus, a micro-processing apparatus, a semiconductor producing apparatus, a surface processing apparatus, a 3-dimensional molding machine, a liquid vaporization apparatus, an organic EL producing apparatus, (particularly, a high-molecular EL producing apparatus), a display producing apparatus, a film forming apparatus, and a DNA chip producing apparatus.

### Used Ink

In the embodiment, the printing example using four colors of ink CMYK is described, but the invention is not limited thereto. The printing may be performed using colors other than CMYK, for example, light cyan, light magenta, white, and clear.

### Piezoelectric Element

In the embodiment, the piezoelectric elements PZT are exemplified as the elements performing the operation for ejecting liquid, but other elements may be used. For example, heating elements or electrostatic actuators may be used.

### Printer Driver

The process of the printer driver may be performed by the printer. In this case, the printing apparatus is including the printer and the PC in which the driver is installed.

The entire disclosure of Japanese Patent Application No. 2010-048844, filed Mar. 5, 2010 is expressly incorporated by reference herein.

What is claimed is:

1. A printing method of printing an image by a printing apparatus ejecting ink from a plurality of nozzles forming nozzle rows to form dots on a medium, wherein the printing apparatus repeatedly performs transportation of transporting the medium in a transport direction and movement of moving the nozzle rows in a scanning direction intersecting the transport direction,
wherein coordinates of dots formed by nozzles of a nozzle row center portion and coordinates of dots formed by nozzles of nozzle row end portions are measured with respect to a ruled line printed in advance along the transport direction by ejecting ink from the plurality of nozzles, and an amount of deviation in the scanning direction among the coordinates is calculated, and
wherein pixel data corresponding to the dots formed by the nozzles of the nozzle row end portions among pixel data indicating unit elements forming an image are shifted in the scanning direction according to the amount of deviation to perform printing.

2. The printing method according to claim 1, wherein the direction the pixel data is to be shifted in is a direction opposite to the direction in which the dots formed by the nozzles of the nozzle row end portions deviate from the dots formed by the nozzles of the nozzle row center portion.

3. The printing method according to claim 1, wherein the time of ejecting ink from the plurality of nozzles is adjusted to land the ink ejected from the plurality of nozzles at the same position in the scanning direction on the medium when the ink is ejected while the nozzle rows move in the scanning direction, and
wherein the ruled line is printed after the time is adjusted.

4. The printing method according to claim 1, wherein the pixel data are not shifted when the calculated amount of deviation in the scanning direction is smaller than a predetermined value.

5. The printing method according to claim 1, wherein the amount of shifting the pixel data gets larger as the calculated amount of deviation in the scanning direction gets larger.

6. The printing method according to claim 1, wherein the coordinates of the dots formed by nozzles of the nozzle row center portion is determined by an average value of the scanning direction of the coordinates of the plurality of dots formed by the nozzles of the nozzle row center portion.

7. The printing method according to claim 1, wherein the process of shifting the pixel data is performed between a half-tone process and a rasterizing process.

8. The printing method according to claim 1, wherein the pixel data is data for printing the ruled line.

9. The printing method according to claim 1, wherein the printing apparatus moves the nozzle rows in the scanning direction intersecting the transport direction, forms dot rows extending in the transport direction on the medium, transports the medium in the transport direction, moves the nozzle rows in the scanning direction intersecting the transport direction, and forms dot rows extending in the transport direction on the more upstream side of the transport direction than the dot rows formed on the medium.

10. The printing method according to claim 1, wherein the amount of deviation in the scanning direction calculated for each nozzle of the plurality of nozzles varies for each nozzle of the plurality of nozzles according to the velocity ink at which is ejected.

11. A printing apparatus comprising:
a head unit that has nozzle rows including a plurality of nozzles, moves in a scanning direction intersecting the transport direction of a medium, ejects ink from the nozzles, forms dots to print an image; and
a control unit that generates image data for printing the image,
wherein the control unit shifts pixel data corresponding to dots formed by nozzles of nozzle row end portions in the scanning direction among pixel data indicating unit elements forming the image, according to an amount of deviation in the scanning direction between coordinates of dots formed by nozzles of a nozzle row center portion and coordinates of the dots formed by the nozzles of the nozzle row end portions.
